(19) United States
(12) Patent Application Publication
(10) Pub. No.: US 2019/0085223 A1
(43) Pub. Date: Mar. 21, 2019

(54) URETHANE ADHESIVE

(71) Applicant: HENKEL AG & CO. KGAA, Duesseldorf (DE)

(72) Inventor: Ai TAKAMORI, Osaka (JP)

(21) Appl. No.: 16/194,476

(22) Filed: Nov. 19, 2018

Related U.S. Application Data
(63) Continuation of application No. PCT/JP2017/019376, filed on May 24, 2017.

(30) Foreign Application Priority Data
Jun. 14, 2016 (JP) 2016-117638

(51) Int. Cl. C09J 175/04

(52) U.S. Cl. CPC C09J 175/04; C08G 18/12; C09J 2400/14

(57) ABSTRACT

Disclosed is a urethane adhesive comprising a urethane polyol, a polyisocyanate, a plasticizer, and a stabilizing agent, wherein the urethane polyol is a polymer of a polyethylene glycol and a polypropylene glycol with an isocyanate monomer, and the plasticizer comprises a castor oil-based compound. With regard to the adhesive, an adhesive layer formed on a substrate (for example, a plastic) is excellent in wettability to a surface of an adherend (preferably glass) and releasability is sufficiently maintained even when exposed to a condition of a high temperature and/or a high humidity for a long time, and also each component is excellent in compatibility. An adhesive film coated with the urethane adhesive is also provided.

### CROSS-REFERENCE TO RELATED APPLICATIONS

This application claims benefit under Paris Convention of Japanese Patent Application No. 2016-117638 filed on Jun. 14, 2016, incorporated herein by reference in its entirety.

### TECHNICAL FIELD OF THE INVENTION

The present invention relates to a urethane adhesive (or urethane pressure sensitive adhesive) applied to adhesive products such as adhesive tapes, adhesive films (or self-adhesive films), and adhesive labels (or self-adhesive labels), and particularly protective films which cover windowpanes and displays for mobile phones, smart phones, tablets, TVs and the like.

### BACKGROUND OF THE INVENTION

There have been produced adhesive products (including a substrate and an adhesive layer) such as adhesive tapes, adhesive seals, adhesive films, labels, decoration sheets, and non-slip sheets by applying an adhesive (or pressure sensitive adhesive) to a substrate such as films or sheets of paper and plastic to form an adhesive layer. Recently, adhesives are also employed for surface protective films of liquid crystal displays for mobile phones, smart phones, tablets, PCs, TVs and the like. The surface protective films are attached to adherends such as glass of liquid crystal displays or polarizers for liquid crystal displays. Afterward, the surface protective films are peeled from the adherends when the surface protective films have finished a role to protect the surfaces. Therefore, regarding the adhesive layers formed of the adhesives, even if the protective films are attached to the adherends for a long time, a person can peel off the protective films by his hand, that is, the adhesives should have excellent releasability.

Heretofore, adhesives such as acrylic-based adhesives and rubber-based adhesives have been known as an adhesive. However, the acrylic resin-based adhesives may cause drastic increase in adhesiveness and may generate an adhesive deposit (that is, cohesive failure) on an adherend during peeling due to lack of a cohesive force of an adhesive layer itself as a time passes after being attached to the adherend.

On the other hand, the rubber-based adhesives generally comprise additives such as a tackifier resin and a plasticizer in large amounts. Therefore, as a time passes after being attached to an adherend, these additives might be segregated as a bleed. As a result, adhesiveness of the adhesives might degrade and an adhesive deposit remains on the adherend during peeling.

As one of means for solving these problems, a urethane adhesive is sometimes used (see Patent Document 1 and Patent Document 2).

Patent Document 1 discloses a pressure sensitive adhesive which is obtained by preparing a composite resin of a copolymer of unsaturated monomers with a urethane resin and mixing the composite resin with a multifunctional polyisocyanate compound (see [claim 1], [0041]-[0054] and [0066]-[0067] of Patent Document 1).

Patent Document 2 discloses a urethane pressure sensitive adhesive which is obtained by mixing a polyurethane polyol, a multifunctional isocyanate compound and a fatty acid ester (see [claim 1], [0046]-[0047] of Patent Document 2).

When compared with the acrylic-based adhesives and the rubber-based adhesives, the urethane pressure sensitive adhesives of Patent Documents 1 and 2 can inhibit segregation of a bleed and generation of an adhesive deposit, and also can maintain a certain level of properties with regard to releasability after a long period (or a long time passes).

However, the urethane pressure sensitive adhesives of both Patent Documents do not have enough releasability when a time passes under a condition at a high temperature and/or at a high humidity.

Moreover, when a urethane adhesive (or pressure sensitive adhesive) is used for protective films of windowpanes, the urethane adhesive should include additives in a large amount, since the urethane adhesive easily turns yellow by ultraviolet light. As a result, the additives in a large amount might cause degradation of compatibility of the adhesive, and bleed might be generated.

Furthermore, some urethane adhesives have poor wettability with regard to a glass and it takes a long time to cover entirely the surface of the glass with a film, so that air enters into an interface between the film and the glass, which causes floating of the film from the glass.

### PATENT LITERATURE

[PTL 1] JP 2000-328035 A
[PTL 2] JP 2011-190420 A

### SUMMARY OF INVENTION OF THE INVENTION

### Technical Problem

An object of the present invention is to provide an adhesive in which an adhesive layer formed on a substrate (for example a plastic) is excellent in wettability to a surface of an adherend (preferably glass) and releasability is sufficiently maintained even when exposed to a condition of a high temperature and/or a high humidity for a long time, and also each component is excellent in compatibility.

### Solution to Problem

The present inventors have intensively studied so as to solve the problems mentioned above, and found that when a polyol and a plasticizer as raw materials of a urethane adhesive are limited to specific ones, it is possible to obtain a urethane adhesive having excellent wettability to glass and excellent compatibility of each component without causing degradation of releasability between a protective film and glass, thus completing the present invention.

In an aspect, the present invention provides a novel urethane adhesive comprising a urethane polyol, a polyisocyanate, a plasticizer, and a stabilizing agent, wherein

the urethane polyol is a polymer of a polyethylene glycol and a polypropylene glycol with an isocyanate monomer, and

the plasticizer comprises a castor oil-based compound.

In an embodiment, the present invention provides a urethane adhesive comprising the plasticizer in an amount of from 3 to 30 parts by weight based on 100 parts by weight of the total weight of the polyethylene glycol, the polypropylene glycol, the isocyanate monomer, the plasticizer, and the stabilizing agent.

In another embodiment, the present invention provides a urethane adhesive, wherein the castor oil-based compound has a viscosity of from 5 to 400 mPa·s at 25° C.

In a further embodiment, the present invention provides a urethane adhesive comprising a urethane prepolymer which is a polymer of a urethane polyol and a polyisocyanate, a plasticizer, and a stabilizing agent.

In another aspect, the present invention provides an adhesive film coated with a urethane adhesive.

In a further aspect, the present invention provides a member protected with an adhesive film.

In a preferable aspect, the present invention provides a novel process for producing a urethane adhesive, which comprises steps of:

mixing a polyethylene glycol and a polypropylene glycol with an isocyanate monomer to prepare a urethane polyol; and

further mixing the urethane polyol with a polyisocyanate to prepare a urethane prepolymer, wherein

the urethane prepolymer comprises a plasticizer and a stabilizing agent, and

the plasticizer comprises a castor oil-based compound.

### Advantageous Effects of Invention

The urethane adhesive of the present invention is a urethane adhesive comprising a urethane polyol, a polyisocyanate, a plasticizer, and a stabilizing agent, wherein the urethane polyol is a polymer of a polyethylene glycol, a polypropylene glycol, and an isocyanate monomer, and the plasticizer comprises a castor oil-based compound.

Therefore, it is possible to uniformly laminate a film with a glass together within a short time and releasability of the adhesive does not degrade even under a severe condition such as at a high temperature and at a high humidity, thus making it possible to easily peel the film from the glass after a given period (or after a time passes for a given period).

The urethane adhesive of the present invention causes no bleeding because of excellent compatibility with additives such as a plasticizer and a stabilizing agent, and also causes no floating of the film from a glass because of excellent wettability with regard to the glass.

The urethane adhesive of the present invention is excellent in releasability from a glass, a polarizer for liquid crystal displays, etc., and is therefore useful for surface protective films of windowpanes, mobile phones and the like.

### DESCRIPTION OF EMBODIMENTS

The urethane adhesive (or urethane pressure sensitive adhesive) based on the present invention comprises (A) a urethane polyol, (B) a polyisocyanate, (c) a plasticizer, and (d) a stabilizing agent.

The present invention also comprises a kit of components (A), (B), (c), and (d) for obtaining the urethane adhesive based on the present invention.

The components (A), (B), (c), and (d) may be in a state where the four components are respectively separated, and the urethane adhesive may be a so-called two-component (or two-part) adhesive which comprises a first component comprising the components (A), (c), and (d), and a second component comprising the component (B).

The present invention also provides an adhesive comprising a urethane prepolymer obtained by reacting the component (A) with the component (B).

<(A) Urethane Polyol>

The urethane polyol (A) based on the present invention means a compound which has a urethane bond in the chain (inside the compound excluding the end) and has a hydroxyl group at the end.

The urethane polyol (A) is obtainable by a reaction of (a) a polyol with (b) an isocyanate monomer.

In the present invention, the polyol (a) comprises a polyether polyol.

Known polyether polyols can be used as the polyether polyol. The polyether polyols can be obtained by polymerizing a cyclic ether compound such as ethylene oxide, propylene oxide, butylene oxide, or tetrahydrofuran using a low molecular weight polyol such as water, propylene glycol, ethylene glycol, glycerin, or trimethylolpropane as an initiator.

Specifically, polyether polyols having two or more functional groups such as polypropylene glycols (PPG), polyethylene glycols (PEG), and polytetramethylene glycols (PTMG) are used.

In the present invention, the polyol (a) comprises both polyethylene glycol and polypropylene glycol. In the urethane adhesive of the present invention, when the polyol (a) comprises both polyethylene glycol and polypropylene glycol, wettability with regard to glass is improved while maintaining releasability. Therefore, a plastic film is brought into contact with a glass plate through the urethane adhesive of the present invention (adhesive layer), thus making it possible to laminate them together within a short time. Since wettability of an adhesive layer with a glass plate is improved, any voids are not generated at the interface, and it is possible to easily remove the adhesive layer from the glass plate after a given period.

The polyether polyols preferably have a number average molecular weight of from 500 to 5,000 and particularly preferably have a number average molecular weight of from 800 to 4,000. When the polyether polyols have a number average molecular weight in the above range, the urethane adhesive of the present invention is preferably excellent in compatibility and it would be preferably difficult for bleed to generate.

The number average molecular weight (Mn) in the present specification means a value which is measured by gel permeation chromatography (GPC) and calibrated with polystyrene standards. Specifically, Mn can be obtained by the following GPC apparatus and measurement method. HCL-8220GPC manufactured by TOSOH CORPORATION is used as a GPC apparatus, and RI is used as a detector. Two TSKgel SuperMultipore HZ-M manufactured by TOSOH CORPORATION are used as a GPC column. A sample is dissolved in tetrahydrofuran, and the solution is allowed to flow at a flow rate of 0.35 ml/min and at a column temperature of 40° C. to obtain a measured value of a molecular weight. By means of a calibration curve using polystyrene having a monodispersed molecular weight as a standard substance, the measured molecular weight is calibrated to obtain the objective Mn.

The polyether polyol preferably has a hydroxyl value of from 30 to 200 mgKOH/g, particularly preferably has a hydroxyl value of from 50 to 150 mgKOH/g. When the polyether polyol has a hydroxyl value in the above range, the urethane adhesive of the present invention may be excellent in balance between cohesive force and adhesiveness, thus making it possible to maintain releasability under a severe condition such as at a high temperature and at a high humidity.

The hydroxyl value as used herein means the number of milligrams of potassium hydroxide required to neutralize acetic acid combined with hydroxyl groups when 1 g of a resin is acetylated.

In the present invention, the hydroxyl value is specifically calculated by the following equation (i).

Hydroxyl value=(Weight of low molecular weight polyol/Molecular weight of low molecular weight polyol)×Mole number of hydroxyl group contained in 1 mol of low molecular weight polyol×Formula weight of KOH×1,000/Weight of polyether polyol (i)

In the present invention, the polyol (a) may further comprises a polyester polyol. When the polyol comprises the polyester polyol, the urethane adhesive of the present invention is more excellent in cohesive force.

In the present invention, the “polyester polyol” means a compound which belongs to “main chain type” polyesters and has ester bonds and hydroxyl groups in the “main chain”. The polyester polyol is generally obtainable by a condensation polymerization reaction of a low molecular weight diol with a dicarboxylic acid and/or an anhydride thereof.

Examples of the dicarboxylic acid include oxalic acid, malonic acid, succinic acid, glutaric acid, adipic acid, pimelic acid, suberic acid, azelaic acid, sebacic acid, decanedioic acid, 2-methylsuccinic acid, 2-methyladipic acid, 3-methyladipic acid, 3-methylpentanedioic acid, 2-methyloctanedioic acid, 3,8-dimethyldecanedioic acid, 3,7-dimethyldecanedioic acid, phthalic acid, terephthalic acid, isophthalic acid, naphthalenedicarboxylic acid, trimellitic acid, trimesic acid, cyclohexanedicarboxylic acid and the like. These dicarboxylic acids are used alone or in combination.

Examples of the carboxylic anhydrides contain acetic anhydride, propionic anhydride, succinic anhydride, maleic anhydride and phthalic anhydride. These carboxylic anhydrides can be used alone or in combination.

Diols having 1 to 3 functional groups are preferable as a low molecular weight diol. Examples of the “diol” include ethylene glycol, 1-methylethylene glycol, 1-ethylethylene glycol, propylene glycol, butanediol, pentanediol, hexanediol, heptanediol, octanediol, nonanediol, decanediol, neopentyl glycol, 2-methyl-1,3-propanediol, cyclohexanedimethanol, 2,4-dimethyl-1,5-pentanediol, 2,4-dibutyl-1,5-pentanediol and the like.

The polyester polyol preferably has a number average molecular weight of from 500 to 3,000 g/mol, and particularly preferably has a number average molecular weight of from 1,000 to 2,500 g/mol. When the polyester polyol has a number average molecular weight in the above range, the urethane adhesive of the present invention may be excellent in compatibility, and it would be difficult for bleed to generate. The number average molecular weight of the polyester polyol can be determined by GPC in a manner similar to the way which is used to determine the number average molecular weight of the polyether polyol.

The polyester polyol preferably has a hydroxyl value of from 30 to 200 mgKOH/g, particularly preferably has a hydroxyl value of from 50 to 150 mgKOH/g. When the polyester polyol has a hydroxyl value in the above range, the urethane adhesive of the present invention may be excellent in balance between cohesive force and adhesiveness, thus making it possible to maintain releasability under a severe condition at a high temperature and/or at a high humidity.

The hydroxyl value of the polyester polyol is calculated by the below equation (ii).

Hydroxyl value=(Weight of low molecular weight diol/Molecular weight of low molecular weight diol)×Mole number of hydroxyl group contained in 1 mol of low molecular weight diol×Formula weight of KOH×1,000/Weight of polyester polyol. (ii)

The isocyanate monomer (b) is not particularly limited as long as the objective urethane adhesive of the present invention is obtainable. The isocyanate monomer preferably comprises at least one selected from aliphatic isocyanates and alicyclic isocyanates. When the isocyanate monomer comprises the above mentioned isocyanate, the urethane adhesive of the present invention has improved weatherability. Therefore, an amount of a stabilizing agent (such as an antioxidant and an ultraviolet absorber) is decreased and compatibility is also improved.

The “isocyanate monomer (b)” based on the present invention does not mean that it is comprised by the aliphatic isocyanate and the alicyclic isocyanate only. As long as an adverse influence is not exerted on releasability and compatibility of the urethane adhesive of the present invention, the isocyanate monomer (b) may comprise an aromatic isocyanate. The isocyanate monomer (b) preferably comprises no ethylenic double bond (for example, ethylene group, butylene group, etc.) from the viewpoint of weatherability.

The “aliphatic isocyanate” as used herein means a compound which has a chain-like hydrocarbon chain in which isocyanate groups are directly combined with the hydrocarbon chain, and also has no cyclic hydrocarbon chain. Although the “aliphatic isocyanate” may comprise an aromatic ring, the aromatic ring is not directly combined with the isocyanate groups.

In the present description, the aromatic ring is not comprised in the cyclic hydrocarbon chain.

The “alicyclic isocyanate” is a compound which has a cyclic hydrocarbon chain and may have a chain-like hydrocarbon chain. The isocyanate group may be either directly combined with the cyclic hydrocarbon chain, or may be directly combined with the chain-like hydrocarbon chain which may be present. Although the “alicyclic isocyanate” may comprise an aromatic ring, the aromatic ring is not directly combined with the isocyanate groups.

The “aromatic isocyanate” means a compound which has an aromatic ring, in which isocyanate groups are directly combined with the aromatic ring. Therefore, a compound, in which isocyanate groups are not directly combined with the aromatic ring, is classified into the aliphatic isocyanate or the alicyclic isocyanate even if it includes an aromatic ring in the molecule.

Therefore, for example, 4,4′-diphenylmethane diisocyanate (OCN—C₆H₄—CH₂—C₆H₄—NCO) corresponds to the aromatic isocyanate, since the isocyanate groups are directly combined with the aromatic ring. On the other hand, for example, xylylene diisocyanate (OCN—CH₂—C₆H₄—CH₂—NCO) corresponds to the aliphatic isocyanate, even though it includes an aromatic ring, since the isocyanate groups are not directly combined with the aromatic ring and combined with methylene groups.

The aromatic ring may be a ring in which two or more benzene rings are fused.

Examples of the aliphatic isocyanate include 1,4-diisocyanatobutane, 1,5-diisocyanatopentane, 1,6-diisocyanatohexane (hereinafter referred to as HDI), 1,6-diisocyanato-2,2,4-trimethylhexane, 2,6-diisocyanatohexanoic acid methyl ester (lysine diisocyanate), 1,3-bis(isocyanatomethyl)benzene (xylylene diisocyanate) and the like.

Examples of the alicyclic isocyanate include 5-isocyanato-1-isocyanatomethyl-1,3,3-trimethylcyclohexane (isophorone diisocyanate (IPDI)), 1,3-bis(isocyanatomethyl)cyclohexane (hydrogenated xylylene diisocyanate), bis(4-isocyanatocyclohexyl)methane (hydrogenated diphenylmethane diisocyanate), 1,4-diisocyanatocyclohexane and the like.

In the present invention, the isocyanate monomer (b) may comprise an aromatic isocyanate as long as the objective urethane adhesive of the present invention is obtainable. Examples of the aromatic isocyanate comprise 4,4′-diphenylmethane diisocyanate, p-phenylene diisocyanate, m-phenylene diisocyanate and the like.

These isocyanate monomers (b) can be used alone or in combination. Particularly, HDI is preferable.

The method for reaction of the polyol (a) with the isocyanate monomer (b) is not particularly limited as long as the urethane polyol (A) based on the present invention is obtainable, and a general urethanation reaction method can be used. For example, it is possible to use bulk polymerization using no solvent and solution polymerization using a solvent and, after appropriately heating and stirring, a catalyst can be optionally used. It is also possible to use various additives, for example, a stabilizing agent (d) during the reaction of the polyol (a) with the isocyanate monomer (b).

The urethane polyol (A) comprises a repeating unit derived from both polypropylene glycol and polyethylene glycol, more specifically at least one selected from oxyethylene groups (—O—CH₂CH₂—) and oxypropylene groups (—O—CH₂CH₂CH₂—, —O—CH(CH₃)—CH₂—, and —O—CH₂—CH(CH₃)—), and comprises urethane bonds (—NH—COO—).

Furthermore, the urethane polyol (A) preferably has a number average molecular weight of from 10,000 to 30,000, and particularly preferably from 12,000 to 25,000.

Furthermore, the urethane polyol (A) preferably has a hydroxyl value of from 3 to 10 mgKOH/g, more preferably from 5 to 8 mgKOH/g, and particularly preferably from 4 to 8 mgKOH/g.

<(B) Polyisocyanate>

The polyisocyanate (B) is a polymer (polymeric isocyanate, or isocyanate dimer and trimer, etc.) of the isocyanate monomer (b) mentioned above. Examples of the polyisocyanate include polymer (dimer, trimer, . . . ) of isophorone diisocyanate, diphenylmethane diisocyanate, and hexamethylene diisocyanate, and the polyisocyanate is particularly preferably a polymer of hexamethylene diisocyanate.

The polyisocyanate is preferably an isocyanurate, a biuret, or an adduct, particularly preferably an isocyanurate, and most preferably an isocyanurate of hexamethylene diisocyanate.

The polyisocyanate (B) is mixed with the urethane polyol (A) to obtain a urethane prepolymer which is a reaction product of the component (A) with the component (B). When the component (B) is an isocyanurate, it is possible for the urethane adhesive of the present invention to uniformly laminate a film substrate with an adherend together within a short time, and releasability is more excellent.

<(c) Plasticizer>

The plasticizer as used herein means a material which is added to a polymer composition and gives the polymer composition flexibility. In the present invention, the plasticizer comprises a castor oil-based compound.

Examples of the castor oil-based compound include castor oils and castor oil derivatives. When the plasticizer comprises a castor oil and/or a castor oil-based derivative, it is possible for a urethane adhesive of the present invention to have excellent compatibility and to have excellent releasability even under a severe condition such as at a high temperature and at a high humidity.

The castor oil is one kind of vegetable oils obtained from seeds of castor oil plants of Euphorbiaceae, and comprises glycerides of unsaturated fatty acids (ricinoleic acid: 87%, oleic acid: 7%, linoleic acid: 3%) and saturated fatty acids (palmitic acid, stearic acid and the like: 3%) in a small amount. Commercially available products can be used as the castor oil-based compounds. Examples of the commercially available products of a castor oil contain LAV (trade name) manufactured by Itoh Oil Chemicals Co., Ltd.

In the present invention, the castor oil derivative means a compound which is obtained by modifying a castor oil (which is one kind of vegetable oils) with introduction of a functional group, oxidation, reduction, replacement of atoms and the like, while the chemical structure and properties of the castor oil are not changed significantly.

Examples of the castor oil derivative include dehydrated castor oils, hydrogenated castor oils, castor oil fatty acids, dehydrated castor oil fatty acids, 12-hydroxystearic acid, castor oil fatty acid esters and the like.

Examples of commercially available products of the castor oil derivative include:

Hydrogenated Castor Oil A (trade name), CO-FA (trade name), DCO-FA (trade name), Ric Cizer S4 (trade name), Ric Cizer C-101 (trade name), and Ric Cizer GR-310 (trade name) manufactured by Itoh Oil Chemicals Co., Ltd;

Blaunon BR-410 (trade name), Blaunon BR-430 (trade name), Blaunon BR-450 (trade name), Blaunon CW-10 (trade name), Blaunon RCW-20 (trade name), Blaunon RCW-40 (trade name), Blaunon RCW-50 (trade name), Blaunon RCW-60 (trade name) and the like manufactured by Aoki Oil Industrial Ltd; and

Castor Wax A (trade name), Newcizer 510R (trade name), Stearic acid Sakura (trade name), Hydrogenated Castor Oil Fatty Acid (trade name), NAA-34 (trade name), NAA-160 (trade name), NAA-175 (trade name) and the like manufactured by NOF Corporation.

The castor oil-based compounds can be used alone or in combination.

An acid value of the castor oil-based compound based on the present invention is preferably 3.0 mgKOH/g or less, and particularly preferably 2.0 mgKOH/g or less. When the acid value is in the above range, the urethane adhesive of the present invention may be excellent in compatibility, thus making it possible to reduce generation of bleed.

On the assumption that all acid groups included in 1 g of the castor oil-based compound are free acids, the “acid value” of the castor oil-based compound is expressed by a calculated value of the number of milligrams of potassium hydroxide required to neutralize the acids. Therefore, even though an acid group exists as a base in an actual system, it is assumed as a free acid. Specifically, the “acid value” based on the present invention is determined by the following equation (iii).

Acid value (mgKOH/g)=(Weight of acid contained in castor oil-based compound/Molecular weight of acid contained in castor oil-based compound)×Mole number of acid group contained in acid of 1 mol contained in castor oil-based compound×Formula weight of KOH×1,000/Weight of castor oil-based compound. (iii)

In the present invention, the castor oil-based compound preferably has a refractive index of from 1.450 to 1.470 N_{P}²⁵. The refractive index generally means a value which is obtained by dividing a light speed in vacuum with a light speed in a material, and specifically means a value which is measured according to JIS K0062-1992. (Furthermore, the refractive index can mean an amount of “resistance” when light goes in a certain material.)

In the present invention, the castor oil-based compound preferably has a melt viscosity of from 5 to 400 mPa·s at 25° C., and particularly preferably from 5 to 300 mPa·s at 25° C.

The melt viscosity at 25° C. as used herein means a value which is measured by No. 27 rotor at a rotation number of 100 using a Brookfield viscometer.

When the melt viscosity of the castor oil-based compound is in the above range, the urethane adhesive of the present invention is excellent in compatibility with regard to additives and the like, is also excellent in wettability to a glass and it would be difficult for bleed to generate, thus making it possible to bring the film into uniformly contact with the glass through the urethane adhesive of the present invention within a short time.

<(d) Stabilizing Agent>

The “stabilizing agent” as used herein is mixed so as to prevent decrease in molecular weight, occurrence of gelation, coloration, odor and the like of the urethane adhesive due to heat, thereby improving stability of the urethane adhesive, and there is no particular limitation as long as the objective urethane adhesive-based on the present invention is obtainable. Examples of the “stabilizing agent” include antioxidants and light stabilizing agents. The light stabilizing agent as used herein is roughly classified into ultraviolet absorbers and hindered amine-based stabilizing agents (HALS).

The “antioxidant” is used to prevent oxidative degradation of the urethane adhesive. Examples of the “antioxidant” include phenol-based antioxidants, sulfur-based antioxidants, phosphorus-based antioxidants and the like.

The “ultraviolet absorber” is a compound which improves weatherability of the urethane adhesive by absorbing ultraviolet light and converting the energy of the ultraviolet light to kinetic energy and/or heat energy which are harmless to plastics. Examples of the ultraviolet absorber contain benzotriazole-based ultraviolet absorbers, benzophenone-based ultraviolet absorbers and the like.

The “hindered amine-based stabilizing agents (HALS)” capture radicals produced by ultraviolet light and exert the effects of preventing coloration and maintaining gloss.

The above mentioned stabilizing agent is not particularly limited as long as the objective adhesive film mentioned below is obtainable and the stabilizing agent can be added to the urethane adhesive.

It is possible to use commercially available products as the stabilizing agent. Examples thereof include Adekastab AO-50 and Adekastab LA-36 (trade name) manufactured by Adeka Corporation; SUMILIZER GM (trade name), SUMILIZER TPD (trade name), and SUMILIZER TPS (trade name) manufactured by Sumitomo Chemical Company Limited; IRGANOX 1010 (trade name), IRGANOX 1330 (trade name), IRGAFOS 168 (trade name), IRGANOX 1520 (trade name), Tinuvine 479 (trade name), and Tinuvne 123 (trade name) manufactured by BASF; and JP-650 (trade name) and JF77 (trade name) manufactured by Johoku Chemical Co., Ltd. These stabilizing agents can be used alone or in combination.

The urethane adhesive of the present invention comprises the above-mentioned components such as (A) a urethane polyol, (B) a polyisocyanate, (c) a castor oil-based compound which is a plasticizer, and (d) a stabilizing agent.

The present invention also comprises a kit of components (A), (B), (c), and (d) so as to obtain the urethane adhesive based on the present invention.

The components (A), (B), (c), and (d) may be in a state where the four components are respectively separated, or the urethane adhesive may be a so-called two-component adhesive which comprises a first liquid (or first component) comprising components (A), (c), and (d), and a second liquid (or second component) comprising a component (B).

The present invention also provides an adhesive comprising a urethane prepolymer obtainable by reacting the component (A) with the component (B).

The urethane polyol (A) is a reaction product of (a) a polyol (comprising a polyethylene glycol and a polypropylene glycol) with (b) an isocyanate monomer.

In the urethane adhesive of the present invention, an amount of the plasticizer (d) is preferably from 3 to 30 parts by weight, particularly preferably from 5 to 20 parts by weight, and most preferably from 7 to 15 parts by weight, based on 100 parts by weight of the total weight of the components (a) to (d).

Therefore, in the urethane adhesive of the present invention, an amount of the plasticizer (d) is preferably from 3 to 30 parts by weight, particularly preferably from 5 to 20 parts by weight, and most preferably from 7 to 15 parts by weight, based on 100 parts by weight of the total weight of the component (A) and the components (c) to (d).

When the amounts of these components are in the above ranges, the urethane adhesive of the present invention exhibits more excellent wettability to a glass surface while maintaining releasability. When a plastic film and glass are laminated together using the urethane adhesive of the present invention, air does not enter into an interface, and thus a protective film does not float from the glass surface. After a given period, it is possible to peel the film from the glass surface.

The urethane adhesive based on the present invention may further comprise other components.

There is no particular limitation on the timing of the addition of the other components to the urethane adhesive as long as the objective urethane adhesive is obtainable.

Examples of the “other components” include a tackifier resin, a pigment, a flame retardant, a catalyst, a wax and the like.

Examples of the “tackifier resin” include styrene-based resins, terpene-based resins, aliphatic petroleum resins, aromatic petroleum resins, rosin esters, acrylic resins, polyester resins (excluding polyester polyols) and the like.

Examples of the “pigment” include titanium oxide, carbon black and the like.

Examples of the “flame retardant” include halogen-based flame retardants, phosphorous-based flame retardants, antimony-based flame retardants, metal hydroxide-based flame retardants and the like.

Examples of the “catalyst” include metal catalysts, for example, tin catalysts (trimethyltin laurate, trimethyltin hydroxide, dibutyltin dilaurate, dibutyltin maleate, etc.), lead-based catalysts (lead oleate, lead naphthenate, lead octenoate, etc.) and other metal catalysts (naphthenic acid metal salt such as cobalt naphthenate); amine-based catalyst such as triethylenediamine, tetramethylethylenediamine, tetramethylhexylenediamine, diazabicycloalkenes and dialkylaminoalkylamines; and the like.

The “wax” is preferably for example, a paraffin wax and a microcrystalline wax and the like.

As long as the objective urethane adhesive based on the present invention is obtainable, a mixing method of the urethane polyol (A), the polyisocyanate (B), the plasticizer (c), and the stabilizing agent (d) is not particularly limited. A mixing order of the components (A), (B), (c), and (d) is not also particularly limited.

The adhesive of the present invention can appropriately include a solvent (for example, ethyl acetate, toluene, etc.), considering that it can be applied easily.

A ratio ((A)/(B)) (weight ratio) of the urethane polyol (A) to the polyisocyanate (B) is particularly preferably from 100/5 to 100/3.

It is possible to produce both one and two component type urethane adhesives based on the present invention without requiring a special mixing method and a special mixing order. The thus obtained urethane adhesive is excellent in compatibility, and is also excellent in releasability from a glass or a polarizer. Releasability of the urethane adhesive does not degrade even under a condition such as at a high temperature and at a high humidity.

A method of applying a urethane adhesive to a substrate is not particularly limited as long as objective adhesive products are obtainable. Examples of the coating (or application) method include various methods such as gravure coating, wire bar coating, air knife coating, die coating, dip coating, and comma coating methods.

Adhesive products based on the present invention have an adhesive layer formed on a substrate, for example, by applying the above-mentioned urethane adhesive to the substrate, and are widely used, for example, as adhesive tapes, adhesive seals, adhesive films, labels, decoration sheets, non-slip sheets and the like in fields of electronic components, woodworking materials, building materials, and sanitary materials etc. The adhesive products can be suitably used as surface protective films of glass plates, polarizers and the like.

The member based on the present invention means a member produced by using the adhesive product, and preferably an adhesive film. Types of the member are not particularly limited as long as the member can be produced using the urethane adhesive mentioned above. Examples thereof include displays for TVs, mobile phones and tablets, windowpanes of houses, glass of automobiles, furniture, diapers, containers and the like.

### EXAMPLES

The present invention will be described for the purpose of describing the present invention in more detail and specific manner by way of Examples. These are exemplary of the present invention and are not to be considered as limiting.

Raw materials for synthesizing urethane adhesives are shown below.

(a) Polyol

### Polyether Polyol

(a1) Polypropylene glycol (Primepol FF3320 (trade name) manufactured by Sanyo Chemical Industries, Ltd, Number average molecular weight (Mn): 3,000, trifunctional, hydroxyl value: 56 mgKOH/g, melt viscosity at 25° C.: 600 mPa·s)

(a2) Polypropylene glycol (Primepol PX1000 (trade name) manufactured by Sanyo Chemical Industries, Ltd, Mn: 1,000, difunctional, hydroxyl value: 112 mgKOH/g, melt viscosity at 25° C.: 200 mPa·s)

(a3) Polytetramethylene ether glycol (Polytetramethylene ether glycol 850 (trade name) manufactured by Mitsubishi Chemical Corporation, Mn: 850, difunctional, hydroxyl value: 132 mgKOH/g, melt viscosity at 25° C.: 320 mPa·s)

(a4) Polyethylene glycol (PEG400 (trade name) manufactured by NOF Corporation, Mn: 400, difunctional, hydroxyl value: 280 mgKOH/g, kinematic viscosity at 100° C.: 7 mm²/s)

(a5) Polyethylene glycol (PEG600 (trade name) manufactured by NOF Corporation, Mn: 600, difunctional, hydroxyl value: 192 mgKOH/g, kinematic viscosity at 100° C.: 11 mm²/s)

Polyester Polyol

(a6) Polyester polyol produced from 3-methyl-1,5-pentane diol/adipic acid (Kuraray Polyol P-1000 (trade name) manufactured by Kuraray Co., Ltd, Mn: 1,000, difunctional, hydroxyl value: 112 mgKOH/g, melt viscosity at 25° C.: 1,500 mPa·s)

(a7) Polyester polyol produced from adipic acid/hexane diol/neopentyl glycol (HS2F-231AS (trade name) manufactured by Hokoku Corporation, Mn: 2,000, difunctional, hydroxyl value: 56 mgKOH/g, melt viscosity at 75° C.: 600 mPa·s)

(a8) Polycarbonate polyol produced from 3-methyl-1,5-pentane diol/1,6-hexane diol (Kuraray Polyol C-1090 (trade name) manufactured by Kuraray Co., Ltd, Mn: 1,000, difunctional, hydroxyl value: 112 mgKOH/g, melt viscosity at 25° C.: 1,800 mPa·s)

(b) Isocyanate Monomer

(b1) Aliphatic isocyanate (Isocyanurate of 1,6-diisocyanatohexane (HDI): Duranate 50M-HDI (trade name) manufactured by Asahi Kasei Chemicals Corporation)

(b2) Alicyclic isocyanate (Isocyanurate of isophorone diisocyanate (IPDI): VESTANAT T1890/100 (trade name) manufactured by Sumika Bayer Urethane Co., Ltd)

(b3) Aliphatic isocyanate (Xylilene diisocyanate (XDI): Takenate 500 (trade name) manufactured by Mitsui Chemicals Inc.)

(c) Plasticizer

(c1) Fatty acid ester (IPM-R (trade name) manufactured by NOF Corporation, Acid value: 0.5 mgKOH/g or less, Refractive index: 1.434 N_{P}²⁵, Melt viscosity: 6.6 mPa·s (20° C.))

(c2) Castor oil-based dibasic acid ester (Ric Cizer S-4 (trade name) manufactured by Itoh Oil Chemicals Co., Ltd, Acid value: 1.00 mgKOH/g or less, Refractive index: 1.442 N_{P}²⁵, Melt viscosity: 9 mPa·s (25° C.))

(c3) Castor oil-based fatty acid ester (Ric Cizer C-101 (trade name) manufactured by Itoh Oil Chemicals Co., Ltd, Acid value: 1.7 mgKOH/g or less, Refractive index: 1.454 N_{P}²⁵, Melt viscosity: 17 mPa·s (25° C.))

(c4) Castor oil-based glycerin ester (Ric Cizer GR-301 (trade name) manufactured by Itoh Oil Chemicals Co., Ltd, Acid value: 2.0 mgKOH/g or less, Refractive index: 1.468 N_{P}²⁵, Melt viscosity: 215 mPa·s (25° C.))

(d) Stabilizing Agent

(d1) Phenol-based antioxidant (Adekastab AO-50 (trade name) manufactured by Adeka Corporation, Melting point: 52° C., Weight average molecular weight (Mw): 531)

(d2) Phenol-based antioxidant (Irganox 1330 (trade name) manufactured by BASF, Melting point: 52° C., Mw: 775.22)

(d3) Phosphorus-based antioxidant (JP-650 (trade name) manufactured by Johoku Chemical Co., Ltd, Melting point: 180° C., Mw: 647)

(d4) Hydroxyphenyltriazine-based ultraviolet absorber (Tinuvine 479 (trade name) manufactured by BASF, Mw: 678)

(d5) Hindered amine-based light stabilizing agent (Tinuvine 123 (trade name) manufactured by BASF, Mw: 737)

<Production of Urethane Adhesive>

The components (a) and (b) are reacted together to synthesize a urethane polyol (A), and then the urethane polyol (A), a polyisocyanate (B), a plasticizer (c), and a stabilizing agent (d) are mixed, thus obtaining a urethane adhesive. The component (d) may be mixed in advance during the reaction of the component (a) with the component (b). Specific production method of a urethane adhesive is mentioned below. All numeric values are based on solid content.

### Example 1

As shown in Table 1, 68.6 parts by weight of a polypropylene glycol (a1), 13.7 parts by weight of a polypropylene glycol (a2), 2.1 parts by weight of a polyethylene glycol (a4), and 0.3 part by weight of a phenolic antioxidant (d1) were charged in a separable flask, stirred and dehydrated at a temperature of 110° C. for 120 minutes in vacuo. Thereafter, 6.5 parts by weight of HDI (b1) was charged in the flask, and the components were reacted by maintaining the temperature in the flask at a temperature of 110° C. for 5 hours to obtain a mixture comprising a urethane polyol (A1) and the component (d1).

8.8 parts by weight of a castor oil-based dibasic acid ester (c2) and 50 parts by weight of ethyl acetate (based on 100 parts by weight of the urethane polyol (A1) contained in the mixture) were added to the mixture, followed by stirring and dissolving at normal temperature to obtain a solution containing the urethane polyol (A1), the component (c2), and the component (d1).

4.2 parts by weight of an isocyanurate of hexamethylene diisocyanate (Coronate HX (trade name) manufactured by TOSOH CORPORATION) as the polyisocyanate (B) was mixed per 100 parts by weight of the urethane polyol solution to obtain a urethane adhesive of Example 1 comprising a urethane prepolymer, the component (c2), and the component (d1).

TABLE 1

| Example | | 1 | 2 | 3 | 4 | 5 | 6 | 7 | 8 | 9 |
|---|---|---|---|---|---|---|---|---|---|---|
| (a) | (a1) | 68.6 | 68.6 | 68.6 | 68.6 | 68.6 | 68.6 | 69.6 | 67.5 | 65 |
| | (a2) | 13.7 | | 13.7 | | | | 14 | 13.5 | 13 |
| | (a3) | | 13.7 | | | | | | | |
| | (a4) | 2.1 | 2.1 | | 2.1 | 2.1 | 2.1 | 1 | 3.5 | 6.5 |
| | (a5) | | | 2.1 | | | | | | |
| | (a6) | | | | 13.7 | 10.1 | 10.1 | | | |
| | (a7) | | | | | 3.6 | | | | |
| | (a8) | | | | | | 3.6 | | | |
| (b) | (b1) | 6.5 | 6.5 | 6.5 | 6.5 | 6.5 | 6.5 | 6.6 | 6.4 | 6.1 |
| | (b2) | | | | | | | | | |
| | (b3) | | | | | | | | | |
| (c) | (c1) | | | | | | | | | |
| | (c2) | 8.8 | 8.8 | 8.8 | 8.8 | 8.8 | 8.8 | 8.5 | 8.8 | 9.1 |
| | (c3) | | | | | | | | | |
| | (c4) | | | | | | | | | |
| (d) | (d1) | 0.3 | 0.3 | 0.3 | 0.3 | 0.3 | 0.3 | 0.3 | 0.3 | 0.3 |
| | (d2) | | | | | | | | | |
| | (d3) | | | | | | | | | |
| | (d4) | | | | | | | | | |
| | (d5) | | | | | | | | | |
| (A) | | 100 | 100 | 100 | 100 | 100 | 100 | 100 | 100 | 100 |
| | | (A1) | (A2) | (A3) | (A4) | (A5) | (A6) | (A7) | (A8) | (A9) |
| (B) | | 4.2 | 4.2 | 4.2 | 4.2 | 4.2 | 4.2 | 4.2 | 4.2 | 4.2 |

| | | | | | | | | | |
|---|---|---|---|---|---|---|---|---|---|
| Urethane adhesive | | | | | | | | | |
| Releasability | 2 | 2 | 2 | 2 | 2 | 3 | 2 | 2 | 3 |
| (Normal | AF | AF | AF | AF | AF | AF | AF | AF | AF |
| temperature) | A | A | A | A | A | A | A | A | A |
| Releasability | 350 | 378 | 380 | 750 | 790 | 780 | 400 | 790 | 720 |
| (Heat | AF | AF | AF | AF | AF | AF | AF | AF | AF |
| resistance) | B | B | B | B | B | B | B | B | B |
| Releasability | 6 | 10 | 8 | 16 | 17 | 13 | 7 | 12 | 15 |
| (Humidity | AF | AF | AF | AF | AF | AF | AF | AF | AF |
| and heat | A | A | A | B | B | A | A | A | A |
| resistance) | | | | | | | | | |
| Wettability | 4 | 9 | 8 | 6 | 7 | 9 | 6 | 5 | 5 |
| (Glass plate) | A | A | A | A | A | A | A | A | A |

TABLE 2

| Example | | 10 | 11 | 12 | 13 | 14 | 15 | 16 | 17 | 18 |
|---|---|---|---|---|---|---|---|---|---|---|
| (a) | (a1) | 68.6 | 68.6 | 68.6 | 68.6 | 68.6 | 68.3 | 71.8 | 65.8 | 63.2 |
| | (a2) | 13.7 | 13.7 | 13.7 | 13.7 | 13.7 | 13.6 | 14.3 | 13.1 | 12.6 |
| | (a3) | | | | | | | | | |
| | (a4) | 2.1 | 2.1 | 2.1 | 2.1 | 2.1 | 2.1 | 2.2 | 2 | 1.9 |
| | (a5) | | | | | | | | | |
| | (a6) | | | | | | | | | |
| | (a7) | | | | | | | | | |
| | (a8) | | | | | | | | | |
| (b) | (b1) | 6.5 | 6.5 | 6.5 | 6.5 | | | 6.8 | 6.3 | 6 |
| | (b2) | | | | | 6.5 | | | | |
| | (b3) | | | | | | 6.9 | | | |
| (c) | (c1) | | | | | | | | | |
| | (c2) | 8.8 | 8.8 | 8.8 | 8.8 | 8.8 | 8.8 | 4.6 | 12.5 | 16 |
| | (c3) | | | | | | | | | |
| | (c4) | | | | | | | | | |
| (d) | (d1) | | 0.2 | 0.2 | 0.2 | 0.3 | 0.3 | 0.3 | 0.3 | 0.3 |
| | (d2) | 0.3 | | | | | | | | |
| | (d3) | | 0.1 | | | | | | | |
| | (d4) | | | 0.1 | | | | | | |
| | (d5) | | | | 0.1 | | | | | |
| (A) | | 100 | 100 | 100 | 100 | 100 | 100 | 100 | 100 | 100 |
| | | (A10) | (A11) | (A12) | (A13) | (A14) | (A15) | (A16) | (A17) | (A18) |
| (B) | | 4.2 | 4.2 | 4.2 | 4.2 | 4.2 | 4.2 | 4.2 | 4.2 | 4.2 |

| Urethane adhesive | | | | | | | | | |
|---|---|---|---|---|---|---|---|---|---|
| Releasability | 2 | 2 | 2 | 2 | 2 | 1 | 2 | 2 | 2 |
| (Normal | AF | AF | AF | AF | AF | AF | AF | AF | AF |
| temperature) | A | A | A | A | A | A | A | A | A |
| Releasability | 300 | 390 | 400 | 300 | 720 | 450 | 480 | 390 | 560 |
| (Heat | AF | AF | AF | AF | AF | AF | AF | AF | AF |
| resistance) | B | B | B | B | B | B | B | B | B |
| Releasability | 7 | 10 | 10 | 9 | 16 | 10 | 15 | 13 | 10 |
| (Humidity | AF | AF | AF | AF | AF | AF | AF | AF | AF |
| and heat | A | A | A | A | A | A | A | A | A |
| resistance) | | | | | | | | | |
| Wettability | 5 | 6 | 6 | 6 | 13 | 15 | 8 | 6 | 8 |
| (Glass plate) | A | A | A | A | B | B | A | A | A |

| | | Example | | Comparative Example | | | | | |
|---|---|---|---|---|---|---|---|---|---|
| | | 19 | 20 | 1 | 2 | 3 | 4 | 5 | 6 |
| (a) | (a1) | 68.6 | 68.6 | 56.4 | 75.2 | | | 70 | 68.8 |
| | (a2) | 13.7 | 13.7 | 11.3 | 15 | | | 14 | 13.8 |
| | (a3) | | | | | | | | |
| | (a4) | 2.1 | 2.1 | 1.7 | 2.3 | 2.4 | | | 2 |
| | (a5) | | | | | | | | |
| | (a6) | | | | | 77.5 | 79.9 | | |
| | (a7) | | | | | | | | |
| | (a8) | | | | | | | | |
| (b) | (b1) | 6.5 | 6.5 | 5.3 | 7.1 | 10.4 | 10.7 | 6.5 | 6.5 |
| | (b2) | | | | | | | | |
| | (b3) | | | | | | | | |
| (c) | (c1) | | | 25 | | | | | |
| | (c2) | | | | | 9.4 | 9 | 9.1 | 8.9 |
| | (c3) | 8.8 | | | | | | | |
| | (c4) | | 8.8 | | | | | | |
| (d) | (d1) | 0.3 | 0.3 | 0.3 | 0.4 | 0.3 | 0.4 | 0.4 | |
| | (d2) | | | | | | | | |
| | (d3) | | | | | | | | |
| | (d4) | | | | | | | | |
| | (d5) | | | | | | | | |
| (A) | | 100 | 100 | 100 | 100 | 100 | 100 | 100 | 100 |
| | | (A19) | (A20) | (A′21) | (A′22) | (A′23) | (A′24) | (A′25) | (A′26) |
| (B) | | 4.2 | 4.2 | 4.2 | 4.2 | 4.2 | 4.2 | 4.2 | 4.2 |

| Urethane adhesive | | | | | | | | |
|---|---|---|---|---|---|---|---|---|
| Releasability | 2 | 2 | 2 | 200 | 1 | 2 | 2 | 2 |
| (Normal | AF | AF | AF | CF | AF | AF | AF | AF |
| temperature) | A | A | A | D | A | A | A | A |
| Releasability | 480 | 490 | 400 | 12 | 1 | 1 | 350 | 1 |
| (Heat | AF | AF | AF | CF | CF | CF | AF | CF |
| resistance) | B | B | B | D | D | D | B | D |
| Releasability | 15 | 15 | 15 | 2 | 1 | 1 | 6 | 2 |
| (Humidity | AF | AF | AF | CF | CF | CF | AF | CF |
| and heat | A | A | A | D | D | D | A | D |
| resistance) | | | | | | | | |
| Wettability | 15 | 13 | 26 | 25 | 10 | 8 | 23 | 6 |
| (Glass plate) | B | B | D | D | A | A | D | A |

### Examples 2 to 20 and Comparative Examples 1 to 6

Urethane polyols (A) ((A2) to (A′26)) were prepared according to the compositions shown in Tables 1 to 3, and each of the urethane polyols (A) was mixed with the polyisocyanate (B) to prepare each of urethane adhesives of Examples 2 to 20 and Comparative Examples 1 to 6 comprising each of urethane prepolymers. Specific method for preparing each urethane adhesive is similar to that mentioned in Example 1.

<Production of Adhesive Sheet for Evaluation>

Each of the urethane adhesives of Examples 1 to 20 and Comparative Examples 1 to 6 was applied to a non-release type polyethylene terephthalate (PET) film (substrate) in a thickness of 10 μm to form each adhesive layer. After the application, each of the adhesive layers was dried at 80° C. for 5 minutes, and a release type PET film was laminated on each surface of the adhesive layers to produce each of adhesive sheets for evaluation.

### <Evaluation Tests>

Following evaluation tests were carried out using the above mentioned adhesive sheets for evaluation. The results of the evaluation tests are shown in Tables 1-3.

1. Releasabilty with Regard to Glass (at Normal Temperature)

A test sheet (25 mm×70 mm) was cut out of the adhesive sheet for evaluation produced by the above-mentioned manner. The release type PET film was removed from the cut out test sheet. The non-release type PET film was placed on a glass plate as an adherend so that the urethane adhesive layer was contacted with the glass plate. Then, a load of 2 Kg was applied by a roller in one stroke to obtain a laminate in which the non-release type PET film is attached to the glass plate through the urethane adhesive layer.

The laminate of the non-release type PET film with the glass plate was stored under an atmosphere at a temperature of 23° C. and at a humidity of 50% for 28 days. Then, under an atmosphere at a temperature of 23° C. and at a humidity of 50%, peel strength of the laminate was measured by peeling the non-release PET film in a direction of 180° at a tension rate of 300 mm/min using a tensile testing machine (manufactured by Shimadzu Corporation). Evaluation criteria are as follows.

A: Interfacial failure (AF) occurred and peel strength was less than 4 g/25 mm.

B: Interfacial failure (AF) occurred and peel strength was 4 g/25 mm or more.

C: Interfacial failure and cohesive failure (AF/CF) occurred.

D: Cohesive failure (CF) occurred.

The “Interfacial failure (AF: adhesive failure)” as used herein means that peeling occurred at an interface between the glass plate and the adhesive layer. Therefore, there was no adhesive deposit on the glass plate. On the other hand, the “Cohesive failur (CF: cohesive failure)” means that the failure occurred inside the adhesive layer. Therefore, at least part of the adhesive layer remained on the glass plate. That is, it means that there was an adhesive deposit. Moreover, since the non-release type PET film was used, no peeling at an interface between the adhesive layer and the PET film was observed.

2. Releasability with Regard to Glass (Heat Resistance)

A laminate of a non-release type PET film with a glass plate, which was obtained by the same manner as that mentioned in the item of “releasability with regard to glass (at normal temperature)”, was stored under an atmosphere at a temperature of 150° C. for 24 hours. Then, the laminate was further stored under an atmosphere at a temperature of 23° C. and at a humidity of 50% for 24 hours. Under an atmosphere at a temperature of 23° C. and at a humidity of 50%, peel strength of the laminate was measured by peeling the non-release type PET film in a direction of 180° at a tension rate of 300 mm/min using a tensile testing machine (manufactured by Shimadzu Corporation). Evaluation criteria are as follows.

A: Interfacial failure (AF) occurred and peel strength was less than 100 g/25 mm.

B: Interfacial failure (AF) occurred and peel strength was 100 g/25 mm or more.

C: Interfacial failure and Cohesive Failure (AF/CF) occurred.

D: Cohesive failure (CF) occurred.

3. Releasabilty with Regard to Glass (Humidity and Heat Resistance)

A laminate of a non-release type PET film with a glass plate, which was obtained by the same manner as that mentioned in the item of “releasability with regard to glass (at normal temperature)”, was stored under an atmosphere at a temperature of 85° C. and at a humidity of 85% for 21 days. Then, the laminate was further stored under an atmosphere at a temperature of 23° C. and at a humidity of 50% for 24 hours. Under an atmosphere at a temperature of 23° C. and at a humidity of 50%, peel strength of the laminate was measured by peeling the non-release type PET film in a direction of 180° at a tension rate of 300 mm/min using a tensile testing machine (manufactured by Shimadzu Corporation). Evaluation criteria are as follows.

A: Interfacial failure (AF) occurred and peel strength was less than 15 g/25 mm.

B: Interfacial failure (AF) occurred and peel strength was 15 g/25 mm or more.

C: Interfacial failure and cohesive failure (AF/CF) occurred.

D: Cohesive Failure (CF) occurred.

4. Wettability with Regard to Glass

A test sheet (100 mm×100 mm) was cut out of the adhesive sheet produced by the above-mentioned manner. The release type PET film was removed from the cut out test sheet. The non-release type PET film was placed on a glass plate as an adherend so that the urethane adhesive layer was contacted with the glass plate, and then a measurement was made and a time was recorded until the urethane adhesive layer became entirely conformable with the glass surface and thus the contact surface between the glass plate and the adhesive layer was wetted entirely.

A: Time required for the contact surface between the glass plate and the adhesive layer to be wetted entirely was less than 10 seconds.

B: Time required for the contact surface between the glass plate and the adhesive layer to be wetted entirely was 10 seconds or more and less than 20 seconds.

D: Time required for the contact surface between the glass plate and the adhesive layer to be wetted entirely was 20 seconds or more.

As shown in Tables 1 to 3, each of the urethane adhesives of Examples 1 to 20 is derived from each of the urethane polyols (A) in which each of mixed polyols (a) comprising both a polypropylene glycol and a polyethylene glycol is used as a raw material.

Each of the urethane adhesives of Examples comprises a urethane prepolymer which is a reaction product of a urethane polyol (A) with a polyisocyanate (B), a castor oil-based compound (c), and a stabilizing agent (d), and exhibited good results in all evaluation items. Each of the urethane adhesives is also excellent in compatibility of each component.

On the other hand, with regard to the urethane adhesives of Comparative Examples, “D” rating is assigned in any one of the evaluation items. In the urethane adhesive of Comparative Example 1 in which the plasticizer (c) comprises no castor oil-based compound, so that wetting the glass plate as the adherend requires a time, resulting in poor wettability. Furthermore, the urethane adhesive of Comparative Example 1 is inferior in compatibility with each component. The urethane adhesive of Comparative Example 2 comprises no plasticizer (c) and therefore has not only poor releasability but also drastically poor compatibility.

In the urethane adhesives of Comparative Examples 3 to 5, each of the urethane polyols (A′) is not derived from both a polypropylene glycol and a polyethylene glycol. The urethane adhesive of Comparative Example 6 comprises no stabilizing agent (d). Therefore, the urethane adhesives of Comparative Examples 3 to 6 are inferior in either wettability or releasability.

The above results revealed that a urethane adhesive, which comprises a urethane polyol synthesized from a mixed polyol of a polypropylene glycol and a polyethylene glycol, a castor oil-based compound, and a stabilizing agent, is excellent in compatibility of each component and does not cause degradation of releasability even under a severe condition such as at a high temperature and at a high humidity, and also enables uniform lamination of a glass plate with a film within a short time.

### INDUSTRIAL APPLICABILITY

The present invention provides a urethane adhesive, and the urethane adhesive is applied to a substrate such as a paper or a plastic, and the coated substrate can be preferably used to produce adhesive products such as an adhesive tape, an adhesive label, and an adhesive film. It is possible to produce more suitably a surface protective film to be attached to displays for mobile phones, smart phones, PCs, tablets, and TVs, windowpanes of houses and the like.

1: A urethane adhesive comprising a urethane polyol, a polyisocyanate, a plasticizer, and a stabilizing agent, wherein
the urethane polyol is a polymer of a polyethylene glycol and a polypropylene glycol with an isocyanate monomer, and
the plasticizer comprises a castor oil-based compound.

2: The urethane adhesive according to claim 1, comprising the plasticizer in an amount of from 3 to 30 parts by weight based on 100 parts by weight of the total weight of the polyethylene glycol, the polypropylene glycol, the isocyanate monomer, the plasticizer, and the stabilizing agent.

3: The urethane adhesive according to claim 1, wherein the castor oil-based compound has a viscosity of from 5 to 400 mPa·s at 25° C.

4: An adhesive film coated with the urethane adhesive according to claim 1.

5: A member comprising according to claim 4.

6: A process for producing a urethane adhesive, which comprises steps of:
mixing a polyethylene glycol and a polypropylene glycol with an isocyanate monomer to prepare a urethane polyol; and
further mixing the urethane polyol with a polyisocyanate to prepare a urethane prepolymer, wherein
the urethane prepolymer comprises a plasticizer and a stabilizing agent, and
the plasticizer comprises a castor oil-based compound.

7: The member of claim 5 which is a protective film cover for windowpanes mobile phones, smart phone, tablets or televisions.

8: A process for forming a laminated protective film comprising the steps of
(1) preparing a urethane adhesive of claim 1;
(2) applying the urethane adhesive onto a surface of a film substrate;
(3) applying a glass surface onto the film substrate whereby the urethane adhesive is sandwiched in between the film and glass substrates.
